(19) United States
(12) Patent Application Publication
(10) Pub. No.: US 2023/0415852 A1
(43) Pub. Date: Dec. 28, 2023

(54) MOORING COMPONENT

(71) Applicant: TFI MARINE LIMITED, BLACKROCK, DUBLIN (IE)

(72) Inventors: Paul McEvoy, Dun Laoghaire, Co Dublin (IE); Conor Casey, Dun Laoghaire, Co Dublin (IE); Osayomwanbor Ehiegharevba, Dun Laoghaire, Co Dublin (IE); Reinaldo Pereira, Dun Laoghaire, Co Dublin (IE)

(21) Appl. No.: 18/254,492

(22) PCT Filed: Nov. 25, 2021
(86) PCT No.: PCT/EP2021/083040

§ 371 Date: May 25, 2023

(30) Foreign Application Priority Data
Nov. 26, 2020 (GB) 2018635.9

(51) Int. Cl. B63B 21/20

(52) U.S. Cl. CPC B63B 21/20; B63B 2021/005

(57) ABSTRACT

A mooring component includes at least one compressive element arranged to undergo compression in response to a tensile stress experienced by the mooring component that induces an extension of the mooring component. A tensile stress experienced by the mooring component up to a first stress value compresses the compressive element in a first stage of compression with a first average stiffness value. A tensile stress experienced by the mooring component above the first stress value and up to a second stress value further compresses the compressive element in a second stage of compression with a second average stiffness value. A tensile stress experienced by the mooring component above the second stress value further compresses the compressive element in a third stage of compression with a third average stiffness value. The first and third stiffness values are greater than the second stiffness value.

The present invention relates to a mooring component, in particular to a mooring component for mooring a floating structure in a body of water.

Floating marine structures, such as floating offshore wind turbines, may use a mooring system connected between the sea bed and the floating marine structure to keep the structure in place. Typically such a mooring system will be designed so that any motion of the floating structure away from its desired position is resisted, and a restoring force is generated, to return the structure to the desired position. The desired position may also include a desired orientation, with the mooring element designed to resist any or all of surge, heave, sway pitch roll, and or yaw motions.

A range of different mooring system types exists, such as catenary, taut and semi-taut. All of these can use a range of mooring components such as chains, synthetic ropes, clump weights, anchors and floats. In shallower water, catenary chain systems are common.

However, these mooring systems are not particularly suitable for the mooring of certain floating marine structures, including floating offshore wind turbines or tidal turbines, in which the mooring lines experience a high average background thrust load due to the operation of the turbine, in addition to the dynamic loads (i.e. the force experienced by the mooring system before dynamic loads are applied, such as that which is applied by the mean wind or current).

With a background thrust, the structure will move to a new position (away from the direction of the background thrust) until the restoring force of the mooring system (i.e. the restoring force which returns a structure to its desired position and increases the further it moves from that position) matches the background thrust. A high background thrust therefore results in a high restoring force from the mooring system.

Under these conditions the stiffness of the mooring system (i.e. the force required to move the floating structure any further) is typically very high, as most mooring systems become progressively stiffer the further the floating structure moves from the desired location. When dynamic forces (i.e. waves) move the floating structure around its new position, this therefore 35 results in very high variable loads (i.e. changes in tension) on the mooring system, requiring larger and more expensive mooring components (to protect against failure).

One approach to the problem is to try to modify the stiffness response of a mooring line by introducing new materials, such as disclosed in WO 2012/127015. These systems may work well when high background thrusts are not present. As discussed in WO 2012/127015, typical catenary chain mooring systems show undesirable stress-strain behaviour in high sea states, owing to the heavy weight of the catenary chains that must be used in order to provide the desired range of movement. Such large chains exert a large load on the floating structure, which subjects the chains, and the components connecting to a floating structure, to high fatigue levels, thus risking failure of the chains.

WO 2012/127015 discloses an alternative mooring system comprising at least one tensile element and at least one compressive element as a proposed solution to overcome the problems encountered with catenary chains.

The Applicant has observed that sea depths in the range of 50 m to 100 m, where it is not uncommon to experience waves of up to 20 m, present a particular challenge for the mooring of floating marine structures. The angle of the mooring line between the platform and the seabed is important as it determines what fraction of the restoring force is applied to keep the platform in position (force resisting surge=tension in mooring line*sine of angle between mooring line and platform). In a shallower environment a much longer length of chain needs to be lifted off the seabed to provide the restoring force than in deeper water, as the wave height and surge is a higher proportion of the water depth. In a fibre rope mooring system the angle is again important as the fibre rope needs to be protected from striking the seabed while having enough length to allow for the required motion of the platform. This can be challenging in shallow environments, where the line length required can often be multiples of the water depth.

Such relatively large waves (with respect to the sea depth) exert a high thrust on a floating marine structure, especially if the mooring system is already stiff owing to a high background load. For a floating offshore wind turbine (FOWT) where the background thrust owing to the turbine can easily exceed 100 tonnes and the mooring system may be very stiff, high wave conditions have the potential to drive mooring system forces beyond 1,000 tonnes. These huge forces require very expensive mooring components and very expensive specialist installation vessels to protect against failure.

The present invention seeks to provide a mooring component which is particularly well suited to high background thrust environments.

When viewed from a first aspect the invention provides a mooring component comprising:
at least one compressive element arranged to undergo compression in response to a tensile stress experienced by the mooring component, wherein the at least one compressive element is arranged such that compression of the at least one compressive element induces an extension of the mooring component;
wherein the at least one compressive element is arranged such that a tensile stress experienced by the mooring component up to a first stress value of the tensile stress compresses the at least one compressive element in a first stage of compression by up to a first fraction of an uncompressed length of the at least one compressive element;
wherein the at least one compressive element is arranged such that a tensile stress experienced by the mooring component above the first stress value of the tensile stress and up to a second stress value of the tensile stress further compresses the at least one compressive element in a second stage of compression by greater than the first fraction of the uncompressed length of the at least one compressive element and up to a second fraction of the uncompressed length of the at least one compressive element;
wherein the at least one compressive element is arranged such that a tensile stress experienced by the mooring component above the second stress value of the tensile stress further compresses the at least one compressive element in a third stage of compression by greater than the second fraction of the uncompressed length of the at least one compressive element;
wherein during the first stage of compression the at least one compressive element exhibits an average stiffness having a first stiffness value, wherein during the second stage of compression the at least one compressive element exhibits an average stiffness having a second stiffness value, and wherein during the third stage of compression the at least one compressive element exhibits an average stiffness having a third stiffness value; and
wherein the first stiffness value is greater than the second stiffness value, and the third stiffness value is greater than the second stiffness value.

The present invention provides a mooring component, e.g. for a mooring line or system. The mooring component includes at least one compressive element that undergoes compression in response to a tensile stress (force) applied to the mooring component to extend the overall tensile length of the mooring component. The tensile stress may, for example, be a result of a thrust exerted by wind or waves on a floating structure to which the mooring component is attached. (Stress is defined as the force per unit area applied to the at least one compressive element; strain is defined as the deformation length (i.e. compression per unit length) of the at least one compressive element).

The compressive element(s) are arranged in the mooring component such that compression of the compressive element(s) results in extension of the mooring component (e.g. owing to the way in which the compressive element(s) are mounted in the mooring component) and thus, for example, of the mooring line or system in which the mooring component is a part.

The at least one compressive element is arranged such that the tensile stress causes a particular response in the compression of the compressive element(s) at different levels of the tensile stress that may be experienced by the mooring component. This (stress-strain) response of the compressive element(s) is such that there are at least three different stages of compression of the compressive element(s) as the compressive element(s) are compressed.

Up to a first stress value of the tensile stress, in a first stage of compression (which could be referred to as the pre-tension stage), the tensile stress causes compression of the at least one compressive element up to a first fraction of its uncompressed length when a tensile stress up to the first stress value is applied. The uncompressed length is the length of the compressive element(s) in its fully uncompressed state when no stress is applied to the compressive element(s) (i.e. corresponding to the zero strain point in the compressive element's stress-strain response curve). In this first stage of compression (during compression of the at least one compressive element from its uncompressed state to being compressed by the first fraction of the uncompressed length), the compressive element(s) have an average stiffness having a first stiffness value.

The at least one compressive element is further arranged such that when an additional tensile stress, above the first stress value and up to a second stress value of the tensile stress, is experienced by the mooring component, this tensile stress causes further compression of the compressive element(s), in a second stage of compression (which could be referred to as the operational stage). The compressive element(s) are arranged such that this additional compression compresses the compressive element(s) by greater than the first fraction and up to a second fraction of the uncompressed length when this additional tensile stress is applied. In this second stage of compression (during compression of the at least one compressive element from the first fraction of the uncompressed length to being compressed by the second fraction of the uncompressed length), the compressive element(s) have an average stiffness having a second stiffness value.

The at least one compressive element is further arranged such that when an additional tensile stress, above the second stress value of the tensile stress, is experienced by the mooring component, this tensile stress causes further compression of the compressive element(s), in a third stage of compression (which may be referred to as the survival stage). The compressive element(s) are arranged such that this additional compression compresses the compressive element(s) by greater than the second fraction of the uncompressed length when this additional tensile stress is applied. In this third stage of compression (during compression of the at least one compressive element by greater than the second fraction of the uncompressed length), the compressive element(s) have an average stiffness having a third stiffness value.

The stress-strain response of the at least one compressive element in the mooring component is such that the average stiffness (the average gradient of the stress-strain response curve) of the compressive element(s) over the first stage of compression (the first stiffness value) is greater than the average stiffness of the compressive element(s) over the second stage of compression (the second stiffness value). The average stiffness of the compressive element(s) over the third stage of compression (the third stiffness value) is greater than the second stiffness value. The average stiffness of the compressive element(s) over the third stage of compression (i.e. the third stiffness value) may also be greater than the first stiffness value.

Thus the at least one compressive element has a stiffness that varies over the stages of its compression. It has a relatively high initial average stiffness, when being compressed (in the first stage). When being compressed further (in the second stage), the average stiffness is lower, but then increases again in the third stage to having an average stiffness that is optionally even greater than in the first stage.

It will be seen that the mooring component of the present invention, with the at least one compressive element having a particular non-linear stress-strain response, provides a particularly beneficial performance for the mooring component, e.g. when it is used as part of a mooring line or system for mooring a floating structure in a body of water. The shape of the mooring component advantageously defines the first, second and third stiffness values, i.e. the response is not simply the stress-strain response of the material (or materials) used to form the mooring component.

In use, when a stress is experienced by the mooring component, e.g. owing to a thrust load that the floating structure to which the mooring component is attached experiences, for a first amount of the stress (i.e. up to the first value of the stress, which may, for example, represent a background thrust experienced by the floating structure), the at least one compressive element is compressed by a relatively small amount (owing to the relatively high average stiffness), providing little extension of the mooring component in the first stage of compression. This pre-tension stage thus only requires the at least one compressive element to compress a small amount of its total length in order to reach the second stage of compression, discussed below, thus increasing the compression distance of the compressive element(s) available in the second (operational) stage. The first stiffness value of the tensile stress may be lower than the average thrust value of a turbine to be moored using the compressive element(s), so that variations in background thrust will still keep the component in the second (operational) compression stage.

Above the first value of the stress, however, this initial stiff response changes to allow a much greater amount of extension of the mooring component, owing to the lower average stiffness of the at least one compressive element in the second stage of compression. The response of the at least one compressive element then changes again, in the third stage of compression, to having a response that is stiffer than in the second stage and optionally even stiffer than in the first stage, such that the at least one compressive element experiences very little compression in the third stage. The third stiffness value is greater than the second stiffness value, optionally at least 50% greater than the second stiffness value. This higher stiffness helps the compressive element to provide a sharp increase in tension as the compression distance of the compressive element is compressed past the second fraction.

This stress-strain response provides an optimised, and particularly beneficial, response to stresses experienced by the mooring component, e.g. compared to the mooring component disclosed in WO 2012/127015. The mooring component disclosed in WO 2012/127015 allows a mooring line to stretch almost to its maximum length under any high background thrust experienced by the mooring line. At this high extension, the mooring line is very stiff and small increases in extension, for example due to wave motion, now result in large increases in tension.

In contrast, the mooring component of the present invention does not stretch by much in the first stage (e.g. in response to the standard (e.g. background) thrust experienced by a mooring line). This helps to maintain a floating structure, moored by the mooring component, in its intended position under a background load, e.g. owing to the thrust from the rotor of a floating offshore wind turbine.

However, above this first value of the stress, the mooring component is able to stretch more freely (in the second stage), owing to the compression of the at least one compressive element of the mooring component. This helps to reduce and smooth out the cyclic, shock and peak loads (e.g. from high waves and winds acting on the floating structure) on the mooring component.

In the third stage of compression, the at least one compressive element becomes stiffer again (and, optionally on average, even stiffer than in the first stage of compression), substantially preventing any further significant extension of the mooring component. Thus a much higher increase in load on the mooring component is required for any further compression.

This higher stiffness response at high compression, during the third stage of compression, helps to provide important safety features for the mooring component. It helps the compressive element to endure very high compressions, e.g. the ultimate limit state (ULS) of the mooring system, while reducing the risk of damage. Such a state may occur, for example, in the event that a floating marine structure is moored with multiple mooring lines, including the mooring component of the present invention, and one or more of the other mooring lines breaks.

Thus it will be appreciated that the stress-strain behaviour of the mooring component of the present invention, in reducing the effect of cyclic, shock and peak stresses, helps to prevent fatigue of the mooring component. This helps to increase the lifetime of the mooring component. The stress-strain response of the mooring component, for at least some of its compression, is preferably a (substantially) non-plastic response, i.e. the component is designed to repeatedly undergo compressions, for example up to the second stiffness value (i.e. during the first and second stages) with minimal loss of performance, such that the mooring component returns to substantially its original shape when an applied tensile stress is subsequently removed. There are also further benefits as a consequence. First, the reduction in the effect of the cyclic, shock and peak loads means that the size and weight of the mooring component (and, e.g., the mooring line or system of which the mooring component is a part) can be reduced, e.g. compared to conventional mooring components. Second, the load requirements on the floating structure and the components which connect to the mooring component can also be reduced.

This all helps to reduce the cost of the mooring component, the mooring line or system of which the mooring component is a part and the floating structure itself which is being moored, both initially during construction and installation, and over the operational lifetime of the mooring component and the moored floating structure. It will be seen that this reduces the cost to produce energy, e.g. when the floating structure being moored is used to generate (e.g. wind) energy.

The mooring component of the present invention may be a component of any suitable and desired mooring line or system, and for mooring any suitable and desired floating structure. The present invention also extends to a mooring system comprising a mooring component as described herein.

Preferably the mooring system comprises a mooring line, wherein the mooring component is arranged between a first section of the mooring line and a second section of the mooring line, such that tensile stress applied to the mooring line acts to compress the compressive element and causes the overall length of the mooring system to increase. The mooring system may comprise two or more of the mooring components connected at points along the same length of mooring line, e.g. directly or indirectly connected to each other (i.e. in series) or there may be one or more mooring lines, each including more than one mooring component (i.e. in parallel).

In one set of embodiments the mooring component is submerged and is connected, directly or indirectly, between a floating structure and the seabed. For example, the mooring component may be connected between a floating structure, such as a floating fish farm or a floating platform (e.g. for a floating offshore wind turbine), and the seabed. The mooring system may comprise one or more mooring components, and a combination of different mooring components may be used. Typically, a mooring system comprises of multiple mooring lines wherein each of these lines may contain one or more mooring components according to an embodiment of the present invention. The number of mooring lines and/or mooring components may be chosen based on the extension required due to the maximum sea state. The mooring system may be a mooring system for a deep sea environment, a tidal flow environment or a shallow water environment. Multiple mooring components connected along the same mooring line may be used to provide a desired extension of that mooring line, in order that the mooring line is able to accommodate a maximum wave height in a given mooring location. The number of components required to achieve a chosen extension length will depend on the length selected for each component.

In another set of embodiments, the mooring component is connected between two (or more) floating structures. The connection may be direct or indirect. Thus, in some embodiments, the component is connected, directly or indirectly, between a first floating structure and a second floating structure and optionally, the floating structures form part of an array. In such embodiments the mooring component can respond to movement of one floating structure by reacting against another floating structure that may have greater inertia.

In a set of preferred embodiments (e.g. when the mooring component is part of a mooring system), the mooring component is connected between a floating structure (e.g. platform) and the seabed. In at least some embodiments the mooring component is preferably connected between the floating structure and a mooring line that is connected to the seabed. The mooring line may comprise any combination of materials and mooring line components, including high modulus ropes (e.g. Dyneema®, wire rope), polymer ropes (e.g. polyester, nylon), chain, shackles, swivels, clump weights, or floats. The connection between the mooring component and the mooring line may be direct or indirect (e.g. via an attachment interface, as outlined below).

In one embodiment the mooring line comprises a catenary mooring chain. Such mooring systems may be used in shallow mooring systems, where mooring can be particularly challenging. It will be appreciated that embodiments of the present invention may be particularly suitable when used with such mooring lines.

A mooring component according to at least preferred embodiments of the present invention may be fitted into an existing mooring line. This may be achieved by removing a length of the mooring line of approximately the same length as the mooring component when experiencing a compressive stress approximately equal to the background load (e.g. the uncompressed length plus 10%), attaching a first end of the mooring component to a first section of the mooring line and attaching a second end of the mooring component to a second section of the mooring line.

Thus according to a second aspect of the present invention there is provided a method of altering an existing mooring line, comprising removing a length of a mooring line, leaving a first section of mooring line and a second section of mooring line; and inserting a mooring component according to the first aspect into the mooring line by attaching a first end of the mooring component to the first section of the mooring line and attaching a second end of the mooring component to the second section of the mooring line. All of the optional features disclosed herein with reference to the first aspect of the present invention apply likewise to the present method.

The floating structure may comprise a floating platform for a floating offshore wind turbine, for example. The floating platform may be any suitable and desired type of floating platform (e.g. for a floating offshore wind turbine), such as a semi-submersible platform, a spar platform, a barge platform or a tension leg platform. The type of platform may dictate the response that is desired from the mooring system and thus the mooring component. For example, a different response may be necessary depending on the depth of the water in which the mooring component is to be used, or depending on the type of platform, e.g. whether the mooring system is required to provide stability.

The mooring component preferably comprises an attachment interface at one or both (e.g. each) end of the mooring component. The attachment interface is preferably designed and optimised for connecting the mooring component to other components in a mooring system, for example to tether lines and anchors. It is preferably a pad-eye or h-link type connector to allow for attachment to the rest of the mooring system with a shackle or pin.

The mooring component optionally comprises a polymer compressive element arranged within a structure which converts the applied tensile stress into a compressive stress on the polymer, i.e. the structure transmits the tensile stress experienced by the mooring component (e.g. owing to the thrust on the mooring system) to the at least one compressive element of the mooring component.

In one embodiment the mooring component comprises a first inner plate connected to one end of the compressive element, a second inner plate connected to the other end of the compressive element, a first outer plate adjacent to the first inner plate for connecting to a first portion of a mooring line, a second outer plate adjacent to the second inner plate for connecting to a second portion of a mooring line, a first connecting member connected to the first inner plate and the second outer plate (and, e.g., that extends through the second inner plate), and a second connecting member connected to the second inner plate and the first outer plate (and, e.g., that extends through the first inner plate). In some embodiments the outer plates contain the attachment interfaces.

This embodiment provides one example of how the compressive element may be included in a mooring component and, for example, included in a mooring line or system, in which tension in the mooring line compresses the compressive element, resulting in an overall increase in the length of the mooring line. Thus, the tensile stress experienced by the mooring component is converted into, and thus causes the compressive element to experience, a compressive stress.

In an alternative arrangement, the outer plates can be eliminated with the attachment interfaces attached directly to the ends of the connecting members which extend through the inner plates.

The first and second connecting members may be provided in any suitable and desired way. In one embodiment the first and second connecting members comprise first and second connecting rods. Preferably the first and second connecting members each comprises a bar, e.g. a hollow bar having a rectangular cross-section or a bar having an I-beam shape. This helps to provide an arrangement having a low weight which is still rigid and has a relatively low risk of twisting. Using an I-beam helps to provide a bar that may be easier to weld. Furthermore, with an I-beam, the quality of any welding that is necessary can be confirmed after welding. In a second embodiment the first and second connecting member comprise first and second ropes and/or chains (e.g. a stiff rope such as wire or aramid). While such connecting members do not provide stiffness or resistance to twisting, they do provide a lighter, lower cost mooring component which may be more suitable for some mooring systems.

The weight of the connecting members and plates that connect to the compressive element may be an important factor when they are provided in a mooring component, line or system. This is because, in many applications, it is preferred that the weight of the mooring component in the water (e.g. including the compressive element, the plates and the connecting members) is substantially equivalent, or at least as close as is achievable, to the weight in the water of a conventional catenary mooring chain (or other mooring line), to which the mooring component may be attached. Providing a hollow bar (or I-beam), for the connecting members helps to achieve this.

It may be, in some embodiments, that the compressive element may be heavier than the length of chain that it replaces, since it may be desired to provide the same strength as the chain, even when the mooring component is extended and the compressive element is compressed (e.g. up to 50% of the uncompressed length).

In one embodiment the first and second connecting members are metal, preferably steel. This choice of material helps to provide a structure that is rigid and low weight, and connecting members that are low cost and sufficiently strong. Furthermore, in at least preferred embodiments, the connecting members have a reduced risk of twisting, e.g. owing to the cross-sectional shape of the first and second connecting members.

In one embodiment one or more (e.g. all of) the first inner plate, the second inner plate, the first outer plate and the second outer plate comprise a flat ring. This helps to provide a plate capable of attaching to a number of connecting members as required, and withstanding the necessary forces, while reducing the weight of these components.

In at least some embodiments (e.g. when the mooring component is part of a mooring system), the mooring component is arranged to be placed close to the surface of the water. This helps to minimise stress on the rest of the mooring system. It also helps to ensure that wave or tidal motion causes only the mooring component (and not the entire mooring system) to stretch.

The at least one compressive element of the mooring component may be provided in any suitable and desired way such that it is arranged to undergo compression in response to a tensile stress experienced by the mooring component and that compression of the at least one element induces an extension of the mooring component.

In a preferred set of embodiments, the at least one compressive element comprises at least one elastomeric compressive element. The Applicant has found that using an elastomer to form the at least one compressive element helps to be able to provide the desired stress-strain response of the mooring component.

In a preferred embodiment the at least one elastomeric compressive element comprises a hollow elastomeric bellowed shaped spring, where the shape of the bellows defines the first, second and third stiffness values. The bellowed spring comprises a series of one or more convolutes, where the diameter of the part increases to a maximum and then decreases to a minimum along a length of the spring (the pitch). The spring can be defined by one or more (e.g. all) of: the number of convolutes, the outer and inner diameters, the convolute pitches, the thickness profiles along the pitch, and the convolute shape. In one embodiment all of the convolutes are identical, having the same inner diameter, the same outer diameter, the same convolute shape, the same pitch and the same pitch profile. In this embodiment each convolute can be considered as two mirrored half convolutes, with the entire spring being assembled from these half convolute shapes, or shells.

The overall stress strain response of the bellowed spring is defined by the individual shell shapes and the interaction of these shapes with each other as the spring compresses. The (polymer) spring may be manufactured as a single spring or assembled from a series of shell shapes, attached together to form the overall spring. Such attachment may be through welding, gluing, mechanical fastening, or any other suitable method, e.g. which produces a strong attachment which can resist the applied stresses during compression. These stresses may result in tensile as well as compressive forces across the attached region.

In one embodiment, the shells are all identical and produced through a low pressure injection moulding process, e.g. with the attachment of the shells to each other being achieved through hot plate welding.

Thus, in a set of embodiments the (e.g. each) compressive element can be considered as comprising a plurality of shells (i.e. two or more shells). Optionally each of the plurality of shells comprises a first annular portion, a second annular portion and a central section. Preferably the first annular portion and the second annular portion each lie in a plane that is substantially perpendicular to a central axis of the compressive element. Preferably the first annular portion has a maximum dimension in a direction substantially perpendicular to the central axis that is greater than a maximum dimension of the second annular portion in a direction substantially perpendicular to the central axis. Preferably the central section connects and extends between the first annular portion and the second annular portion. Although described as separate components for convenience of explanation, any or all of the first annular portion, the second annular portion and the central section may be formed integrally.

Preferably the plurality of shells are arranged along the central axis such that the first annular portion of one of the plurality of shells is joined to the first annular portion of an adjacent shell of the plurality of shells or such that the second annular portion of one of the plurality of shells is joined to the second annular portion of an adjacent shell of the plurality of shells.

Preferably the (e.g. each) compressive element is arranged such that when a compressive stress is applied to the compressive element substantially in the direction of the central axis, the compressive element is compressed.

The at least one compressive element, in a first stage of compression (i.e. the response of a first section of its stress-strain curve), undergoes (e.g. elastic) compression when a tensile stress up to a first stress value is applied to the mooring component. Exposed to this first stress value, the at least one compressive element is compressed by the first fraction of its uncompressed length (i.e. the at least one compressive element has its length reduced by the first fraction of its uncompressed length).

The first fraction of the uncompressed length may be any suitable and desired value by which the at least one compressive element is compressed by during the first stage of compression, when the at least one compressive element has an average stiffness having a first stiffness value. In one embodiment the first fraction is between 10% and 20%, e.g. approximately 15%, of the uncompressed length. Thus, when the mooring component experiences a tensile stress equal to the first stress value, preferably the at least one compressive element is compressed to a resultant length that is between 80% and 90%, e.g. approximately 85%, of its uncompressed length.

Optionally the compression of the at least one compressive element is approximately (e.g. directly) proportional to the tensile stress experienced by the mooring component up to the first value of the tensile stress, i.e. preferably the stress-strain curve of the at least one compressive element is approximately linear in the first stage of compression. Preferably the gradient of the stress-strain curve of the at least one compressive element is positive for all values of the tensile stress up to the first stress value.

The first value of the tensile stress may be chosen in any suitable and desired way, e.g. depending on the intended use for the mooring component. Preferably the at least one compressive element is arranged (e.g. manufactured) such that the first value of the tensile stress is slightly below the tensile stress expected to be experienced by the mooring component in benign conditions (i.e. low operational wind thrust with low waves and current). The first value of the tensile stress may therefore be the lowest load that a mooring system using the compressive element is expected to have to operate at, taking into account the dynamic loads around the average thrust in benign conditions. The first stress value may be a significant fraction of the average thrust, e.g. at least 70%, optionally at least 80%, further optionally at least 90%.

The first value of the tensile stress may be determined, as appropriate (and, e.g., the at least one compressive element manufactured and assembled accordingly), for the particular conditions (e.g. location) that the mooring component is expected to experience, e.g. when installed in a mooring system for a floating structure. For example, for a floating offshore wind turbine the background thrust may be determined from one or more (e.g. all) of the size of the turbine, the operational wind conditions, the number and alignment of mooring lines, the platform behaviour, and benign environmental conditions. Thus, different mooring components for different applications (e.g. floating structures and/or environments) may be designed differently to provide them with a different value for the first value of the tensile stress.

The at least one compressive element, in the second stage of compression (i.e. the response of a second section of its stress-strain curve, at higher tensile stresses than the first value of the tensile stress), undergoes compression when a tensile stress above the first stress value and up to a second stress value is applied to the mooring component. Exposed to this second stress value, the at least one compressive element is compressed by the second fraction of its uncompressed length (i.e. the at least one compressive element has its length reduced by the second fraction of its uncompressed length).

The second fraction of the uncompressed length may be any suitable and desired value (including the first fraction) by which the at least one compressive element is compressed by during the second stage of compression, when the at least one compressive element has an average stiffness having a second stiffness value. In one embodiment the second fraction is between 40% and 50%, e.g. approximately 45%, of the uncompressed length.

Thus, when the mooring component experiences a tensile stress equal to the second stress value, preferably the at least one compressive element is compressed to a resultant length that is between 40% and 60%, e.g. approximately 50%, of its uncompressed length. Furthermore, for tensile stresses that are experienced in the second stage of compression (i.e. tensile stresses between the first and second stress values), preferably the at least one compressive element is compressed from 80% to 90% (e.g. approximately 85%), at the first stress value, to 40% and 60% (e.g. approximately 50%), at the second stress value, of its uncompressed length.

Thus during the second stage of compression the compressive element may be compressed across a compression distance which is at least twice as long as the distance over which compression occurs in the first (or pre-tension) stage, optionally at least 3 times as long. The second fraction of the uncompressed length may be between approximately 20-50% of the uncompressed length. The distance through which the compressive element(s) is compressed during the second stage, i.e. the distance between the first fraction and the second fraction, is greater than the distance of the first fraction, and may, additionally or alternatively, be greater than a total compression distance in the third (survival) stage. Thus the majority of the change of length of the compressive element(s) during compression occurs during the operational stage.

Preferably the compression of the at least one compressive element is approximately (e.g. indirectly) proportional to the tensile stress experienced by the mooring component between the first and second stress values of the tensile stress, i.e. preferably the stress-strain curve of the at least one compressive element is approximately linear in the second stage of compression (but having a gradient that is less than the gradient of the stress-strain curve in the first stage of compression). Preferably the gradient of the stress-strain curve of the at least one compressive element is positive for all stress values of the tensile stress between the first and second stress values.

Thus, preferably the gradient of the stress-strain curve of the at least one compressive element is positive for all stress values of the tensile stress up to the second value. This helps to prevent the at least one compressive element from getting trapped at a particular compression (which may happen, e.g. if there were to be a negative gradient in the stress-strain curve, or due to small variations in manufacture).

The second value of the tensile stress may be chosen in any suitable and desired way, e.g. depending on the intended use for the mooring component. Preferably the at least one compressive element is arranged (e.g. manufactured) such that the second value of the tensile stress is approximately equal to the tensile stress expected to be experienced by the mooring component under the Ultimate Limit State (the highest unfactored load expected to be experienced by the component). This limit state may occur under a peak state during operation of a turbine (i.e. maximum thrust in a turbine-operational environmental condition), a survival sea state (i.e. maximum wave and wind loading but no thrust from an operating turbine), or an accidental limit state (i.e. highest load experienced when an unexpected condition occurs such as a mooring line breaking).

The second value of the tensile stress may be determined, as appropriate (and, e.g., the at least one compressive element manufactured and assembled accordingly), for the particular conditions (e.g. location) that the mooring component is expected to experience, e.g. when installed in a mooring system for a floating structure. For example, for a floating offshore wind turbine the peak thrust may be determined from the thrust from the peak thrust expected from the wind and/or wave conditions during a once in 50 years storm. Thus, different mooring components for different applications (e.g. floating structures and/or environments) may be designed differently to provide them with a different value for the second value of the tensile stress.

The behaviour of the mooring component undergoes a change when moving from the first to the second stage. In the bellowed spring embodiments, this shift from a stiff to a less stiff response may be achieved through a flexing, deforming or bending of the (polymer) material, enabled by the bellowed shape. The spring may be formed from one or more individual (polymer) materials with different mechanical properties, such that different parts of the spring react differently to applied stress. Thus the desired response may be achieved by varying one or more of a number of features of the compressive element, e.g. bellowed spring.

In some embodiments, the first and/or second and/or third stage of compression of the compressive element may occurs due to contact of adjacent shells of the compressive element with each other. For example, the at least one compressive element may be arranged such that when the compressive stress applied to the at least one compressive element causes the at least one compressive element to be compressed by a particular fraction of the uncompressed length of the compressive element, a first portion of one of the plurality of shells contacts a first portion of an adjacent shell of the plurality of shells. For example, each shell may comprise a shaped or thickened portion, designed to create contact with an adjacent shell at a particular stage of compression of the compressive element. This “shaping” may be a general thickening, or curved, or may be more pronounced, i.e. extending away from the central section of each shell.

For example, in some embodiments, the central section of each of the plurality of shells may comprise the first portion, i.e. the contact portion. In some embodiments the central section of each of the plurality of shells comprises a (first) shoulder portion projecting from the inner surface or the outer surface of the central section. The central section of each of the plurality of shells may comprise more than one (e.g. two) shoulder portions, which may project from the inner surface, or the outer surface of the central section, or a combination of those.

Preferably the (e.g. each) compressive element is arranged such that when the compressive stress applied to the compressive element causes the compressive element to be compressed by a particular fraction of an uncompressed length of the compressive element, a (first) (e.g. the shoulder) portion of one of the plurality of shells contacts a (first) (e.g. the shoulder) portion of an adjacent shell of the plurality of shells.

When adjacent shells contact each other at their respective (e.g. shoulder) portions, this causes the “load pathway”, along which the compression stress acts through the contact points between adjacent shells (and which prior to the (e.g. shoulder) portions contacting each other was at the respective first or second annular portions), to have a step change in its angle relative to the central axis. Preferably the change in the load pathway when the (e.g. shoulder) portions contact each other is to reduce the angle between the load pathway and the central axis.

The angle of this load pathway helps to determine the stress-strain behaviour of the compressive element. In particular, the change in the load pathway may help to prevent the gradient of the stress-strain curve from turning negative and/or helps to increase the gradient of the stress-strain curve.

Thus the (first) (e.g. shoulder) portions of adjacent shells of the compressive element are arranged to contact each other at a particular fraction of the uncompressed length. The particular fraction may take any suitable and desired value.

The particular fraction may be selected such that a desired stress-strain response may be achieved, e.g. owing to this being the fraction of the uncompressed length at which the angle of the load pathway experiences a step change. The particular fraction may also be the fraction of the uncompressed length at which the compressive element begins to deform significantly under compression. As explained above, the contacting of the (e.g. shoulder) portions of adjacent shells and the changing of the angle of the load pathway helps to prevent the gradient of the stress-strain curve from turning negative.

It will be appreciated that the stiffness response of the compressive element, before and after the particular fraction of the uncompressed length at which the (e.g. shoulder) portions contact each other, and indeed the value of the particular fraction itself, may be determined by a number of features and parameters of the compressive element, in addition to the (e.g. shoulder) portion as described above. For example, the compressive element may be arranged such that, in the second stage of compression, the compression (and thus the stiffness behaviour) of the compressive element is dominated by deformation of the central sections of the compressive element.

The behaviour of the compressive element in the second stage of compression may be controlled by arranging the compressive element such that one or more (e.g. all) of the maximum dimension (e.g. diameter) of the first annular portion increases, the maximum dimension (e.g. diameter) of the second annular portion decreases, and the central section deforms (e.g. bends). Since the portions of the compressive element are three-dimensional, complex shaping may also be used to achieve the desired result. For example, the second annular portion may be arranged to bend inwards as the compressive stress is increased to compress the compressive element by more than the particular fraction. This helps to shrink the diameter of the second annular portion and thus allows for further compression of the compressive element under further increases of the compressive stress.

In some embodiments, the central section is configured to deform (e.g. bend, as opposed to simply flexing relative to the first and second annular portions) when the compressive stress exceeds a threshold that causes the compressive element to be compressed by more than the particular fraction. This could be achieved by the first and second annular portions being arranged to be more resistant to deformation (e.g. stronger) than the central section, e.g. such that their resistance to hoop stress deformation is stronger than any resistance to hoop stress and/or buckling deformation in the central section. This may be achieved in any suitable and desired way.

In some embodiments, additionally or alternatively, the first annular portion and/or the second annular portion is configured to deform when the compressive force exceeds the threshold that causes the compressive element to be compressed by more than the particular fraction. For example, the first annular portion and/or the second annular portion may have a hoop stress which is overcome when the compressive element is compressed by greater than the particular fraction. It will be appreciated that this change may cause at least a portion of the central section to rotate, e.g. to flex towards a direction substantially perpendicular to the central axis.

Thus in such embodiments, the hoop stress of the annular portions may be exceeded and the annular portions may then deform under the applied compressive stress. This may result in a change in the stress-strain behaviour of the compressive element, allowing for a larger amount of compression of the compressive element for a relatively small increase in the applied compressive stress.

This control of the stress-strain behaviour of the compressive element may be achieved, in one embodiment, by using a softer or thinner material in the annular portions (owing to the change in diameter due to hoop stress being related to the applied stress, and the thickness, diameter and material strain of the annular portions), or by varying the (e.g. thickness of the) annular portion radially.

Regardless of how the compression behaviour in the second stage is achieved, preferably the compressive element is arranged to maintain smooth deformation or bending behaviour (e.g. Euler buckling), throughout the compression of the compressive element, e.g. throughout the first, second and/or third stage of compression. This may be achieved, for example, by reducing or even avoiding any limit point instability in the design, an instability being a position at which the shell structure undergoes a large deformation into a different shape which is also stable.

Such instability could cause a negative stiffness at some point along the stress-strain response curve of the compressive element, allowing the applied compressive stress to snap between different shells, causing some shells to collapse while others relax back to their original lengths. Such behaviour creates high fatigue both on the compressive element and on a mooring system including such a compressive element, as loads constantly snap up and down.

The at least one compressive element, in the third stage of compression (i.e. the response of a third section of its stress-strain curve, at higher tensile stresses than the second value of the tensile stress), undergoes compression when a tensile stress above the second stress value is applied to the mooring component. Exposed to this tensile stress of greater than the second stress value, the at least one compressive element is compressed by greater than the second fraction of its uncompressed length (i.e. the at least one compressive element has its length reduced by more than the second fraction of its uncompressed length).

As outlined above, preferably the second fraction of the uncompressed length is between 40% and 60%, e.g. approximately 50%, of the uncompressed length. Thus, the at least one compressive element is compressed during the third stage of compression, when the at least one compressive element has an average stiffness having a third stiffness value, by more than 40% or 60%, e.g. more than approximately 50%, of the uncompressed length.

Thus, when the mooring component experiences a tensile stress greater than the second stress value, preferably the at least one compressive element is compressed to a resultant length that is at least 50% or 60%, e.g. at least approximately 55%, of its uncompressed length.

Preferably the gradient of the stress-strain curve of the at least one compressive element is positive for all stress values of the tensile stress above the second stress value.

Thus, preferably the gradient of the stress-strain curve of the at least one compressive element is positive for all stress values of the tensile stress up to and greater than the second value. This helps to prevent the at least one compressive element from getting trapped at a particular compression (which may happen, e.g. if there were to be a negative gradient in the stress-strain curve).

The higher stiffness of the at least one compressive element during the third stage of compression may be chosen in any suitable and desired way, e.g. depending on the intended use for the mooring component. Preferably the at least one compressive element is arranged (e.g. manufactured) such that the stiffness of the at least one compressive element during the third stage of compression substantially resists further compression of the at least one compressive element. This helps to provide important safety features for the mooring component. For example, it helps the compressive element to endure very high compressions Preferably, the tension in the compressive element towards the end of the third stage of compression is equal to approximately 1.5-2 times greater than the ultimate limit state (ULS) of the mooring system.

In one embodiment the additional compression of the at least one compressive element during the third stage of compression (further to the compression in the first and second stages) is less than 10%, e.g. less than 5%, of the uncompressed length of the at least one compressive element.

In some embodiments, the third stage of compression of the compressive element occurs owing to contact of adjacent shells of the compressive element with each other.

In some embodiments the compressive element is arranged such that when the compressive stress applied to the compressive element is greater than or equal to the second stress value of the compressive stress, the (e.g. central section of the) adjacent shells come into contact with each other. This helps to increase the stiffness of the compressive element in the third stage of compression through two mechanisms.

First, these (additional) contact points transfer load directly, reducing further buckling of the central section. Second, the load pathway through the compressive element is changed by the contacting of the adjacent shells, by reducing the angle (relative to the central axis) through which further compressive stress is applied to the compressive element and increasing the material area sharing that load.

The adjacent shells of the compressive element may be arranged to contact each other during (e.g. at the beginning of) the third stage of compression in any suitable and desired way

The first and/or second shoulder portions may be arranged in any suitable and desired way on the central portion. In one embodiment the first shoulder portion projects (in a direction) towards the first annular portion. Preferably the first shoulder portion has a thickness (e.g. through the shell) that is greater than the thickness of the central section adjacent to (e.g. either side of) the first shoulder portion.

In some embodiments the first shoulder portion is shaped so that, when the compressive stress applied to the compressive element causes the compressive element to be compressed by the particular fraction of the uncompressed length of the compressive element, the first shoulder portion (in this compressed configuration) projects further towards the adjacent shell (in a direction parallel to the central axis) than any other part of the central section (i.e. other than the (e.g. first) annular portion joining the adjacent shells). This helps the first shoulder portion to contact an adjacent shell before the central section would otherwise do.

To achieve this effect, the first shoulder portion need only project further (e.g. in the direction of the central axis) than the rest of the central section, at the stage of compression at which contact between the first shoulder portions occurs. Since the angle of the central section changes (relative to the central axis) during compression, the first shoulder portion therefore need only extend further in this direction at the stage of compression at which contact occurs, not necessarily when the compressive element is unstressed.

Each shell (and thus the compressive element) may be made out of any suitable and desired material. Any chosen material should have suitable fatigue properties to allow for the frequent changes in shape that will be applied by wave motion. Preferably the compressive element comprises a (thermo)polymer, e.g. an elastomer. The spring may be formed from one or more individual polymer materials with different mechanical properties, each material applied to a different part of the polymer spring such that the different parts of the spring react differently to the same applied stress. In one embodiment the first and/or second annular portions comprise a (e.g. elastomeric) material that is stiffer than the material of the central section. For example, the first and/or second annular portions may be made of a higher grade or stiffer polymer (e.g. elastomer) material.

In some embodiments the central section extends continuously in an azimuthal direction around the central axis. Preferably the central section comprises a cross sectional profile (in a plane that contains the central axis) rotated (e.g. through 360 degrees) about the central axis. This may enable the central section to be formed as a single (integral) piece, e.g. in a single stage, e.g. using a single mould.

In some embodiments the material at the inner and outer diameters along the spring length is formed separately from the rest of the material, forming discrete annular rings. The annular rings may then be joined together with central, or shaped, sections to form the desired shell or spring. This may, for example, allow the central section and the first and second annular portions to be formed from different materials. However, preferably the central section is formed integrally with the first and second annular portions. Again, this helps to allow the whole of the shell to be formed as a single (integral) piece, e.g. in a single stage, e.g. using a single mould.

In some embodiments the central section comprises a plurality of discrete sections each connected between the first annular portion and the second annular portion to form a shell. Preferably each discrete section comprises a cross-sectional profile (in a plane that contains the central axis) rotated about the central axis by less than 180 degrees. This may enable the central section of the shell to be formed from less material, e.g. than may be needed to form the central section for a shell of the same size (e.g. overall maximum dimensions) when the central section is a cross-sectional profile rotated through 360 degrees. These smaller central sections may also be easier to manufacture, e.g. using smaller moulds. Thus it may be possible to manufacture the smaller central sections more cheaply, easily and quickly than one continuous central section.

Furthermore, the Applicant has appreciated, unexpectedly, that, in at least preferred embodiments, a spring or shell comprising a plurality of discrete central sections may be able to provide a stress-strain response that is approximately equivalent to that of a shell with a 360 degree central section, while using less material. Preferably the discrete central sections each comprise a cross-sectional profile (i.e. a shaped profile), rotated through less than 90 degrees azimuthally about the central axis, e.g. through less than 45 degrees, e.g. through less than 20 degrees. Preferably the discrete central sections all have the same azimuthal extent, i.e. their cross-sectional profile is rotated through the same angle about the central axis. Preferably the cross-sectional profile of each of the discrete central sections is the same. Preferably the plurality of discrete central sections are equally spaced (e.g. azimuthally) from each other about the central axis.

In addition, or alternatively, to reducing the required material by constructing the shell from sections, the Applicant has further appreciated that material may be removed from certain parts of the shell profile, without substantially affecting the stiffness response of the shell. In particular, the Applicant has appreciated that the stiffness response of the shell may substantially be determined by the material which is present in the shell profile, but that the thickness of such a profile may be varied when rotated around the central axis. Such a profile could result in very thin or no material in some locations while still maintaining the desired overall stiffness profile.

Features of any aspect or embodiment described herein may, wherever appropriate, be applied to any other aspect or embodiment described herein. Where reference is made to different embodiments or sets of embodiments, it should be understood that these are not necessarily distinct but may overlap.

Certain preferred embodiments of the invention will now be described, by way of example only, with reference to the accompanying drawings, in which:

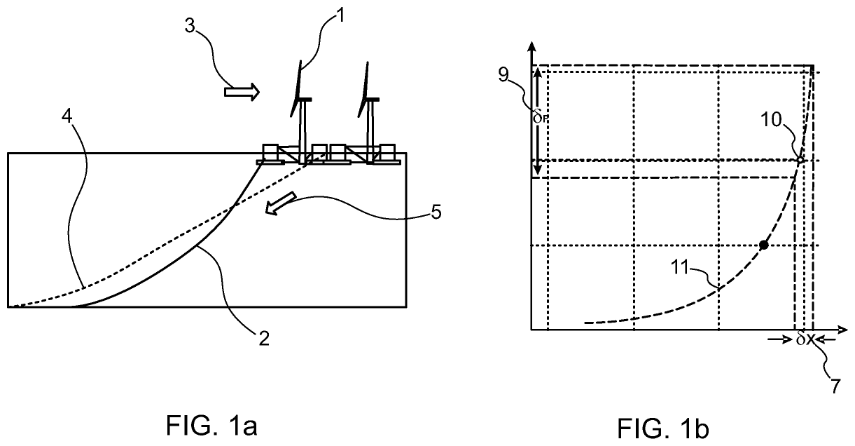

FIG. 1a shows a set of floating offshore wind turbines, moored using a mooring;

FIG. 1b shows the stress-strain response produced by the mooring system shown in FIG. 1a;

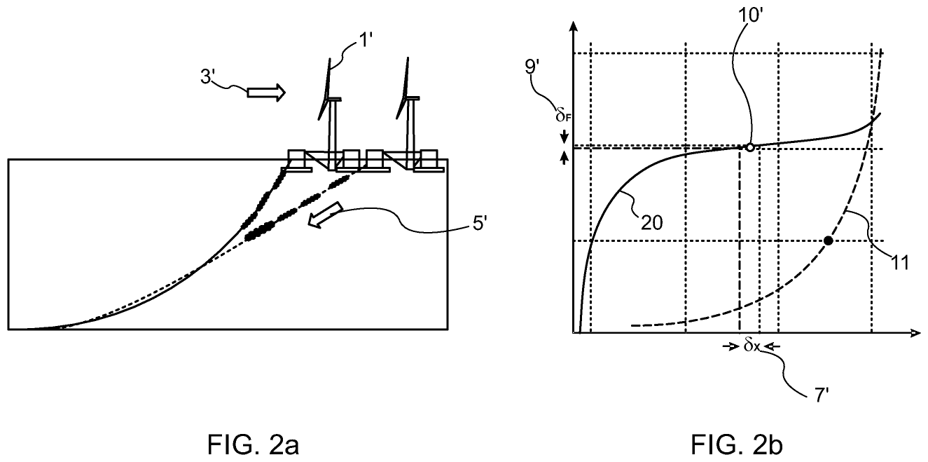

FIG. 2a shows a set of floating offshore wind turbines, moored using a mooring line according to an embodiment of the present invention;

FIG. 2b shows the stress-strain response produced by the mooring system shown in FIG. 2a;

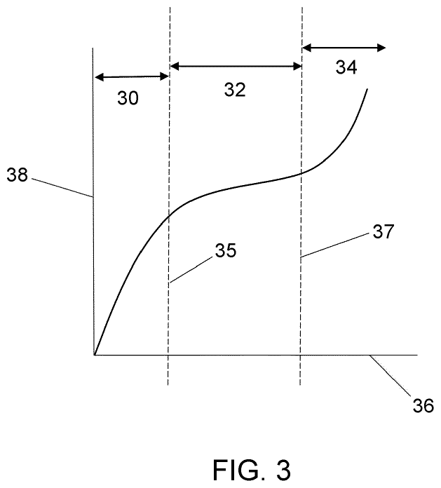

FIG. 3 shows an example of a desirable stress-strain response for a mooring system;

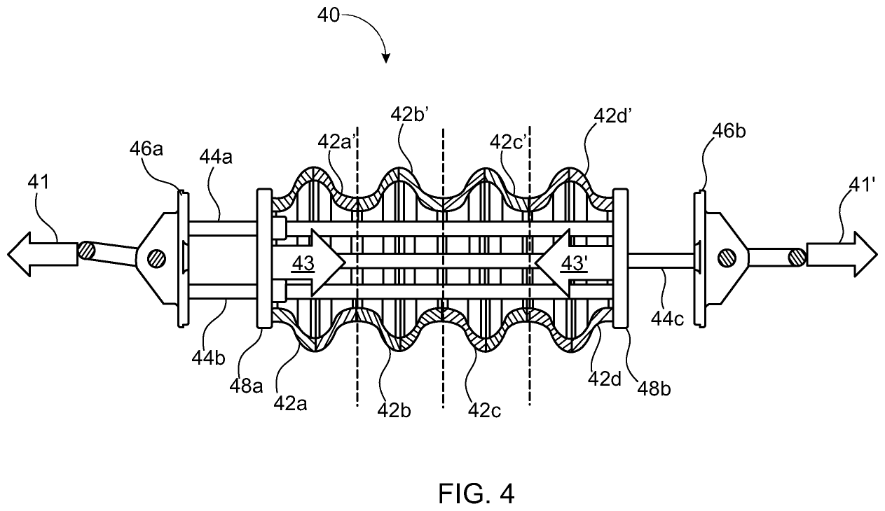

FIG. 4 shows a cross-sectional view of an elastomeric compressive element according to an embodiment of the present invention;

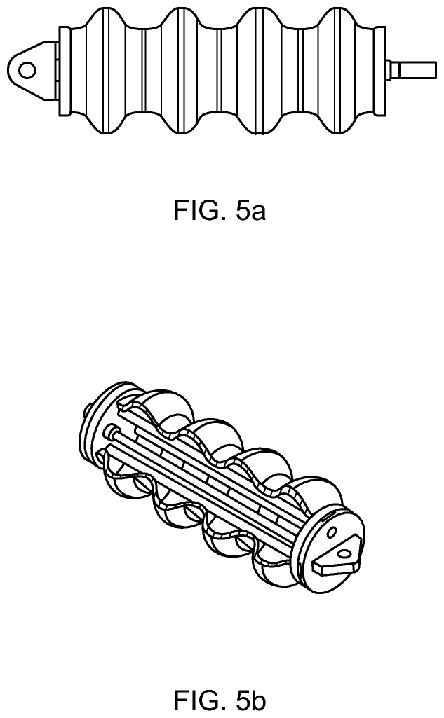

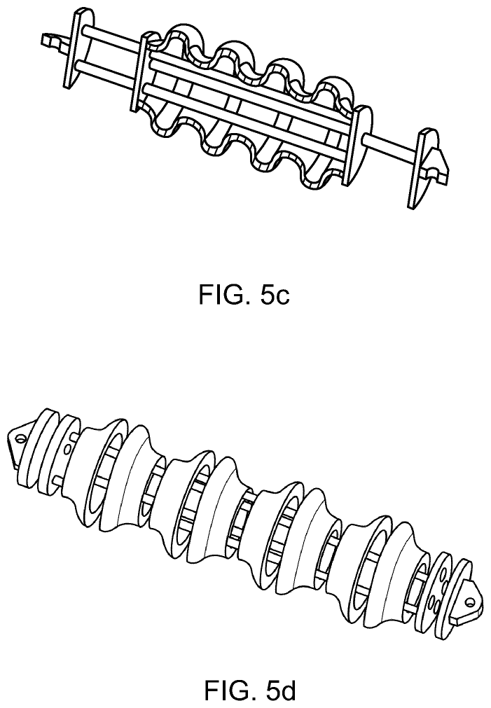

FIG. 5a shows the external appearance of the elastomeric compressive element shown in FIG. 4;

FIG. 5b shows a cutaway perspective view of the elastomeric compressive element shown in FIG. 4;

FIG. 5c shows a cross-sectional view of the elastomeric compressive element shown in FIG. 4;

FIG. 5d shows an exploded perspective view of the elastomeric compressive element shown in FIG. 4;

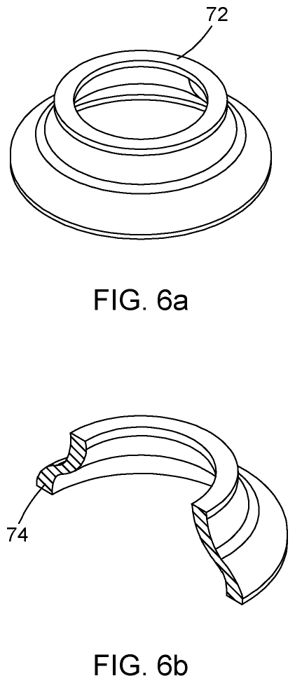

FIG. 6a shows a perspective view of a single shell of the elastomeric compressive element shown in FIGS. 5a to 5d;

FIG. 6b shows a cutaway perspective view of the single shell shown in FIG. 6a;

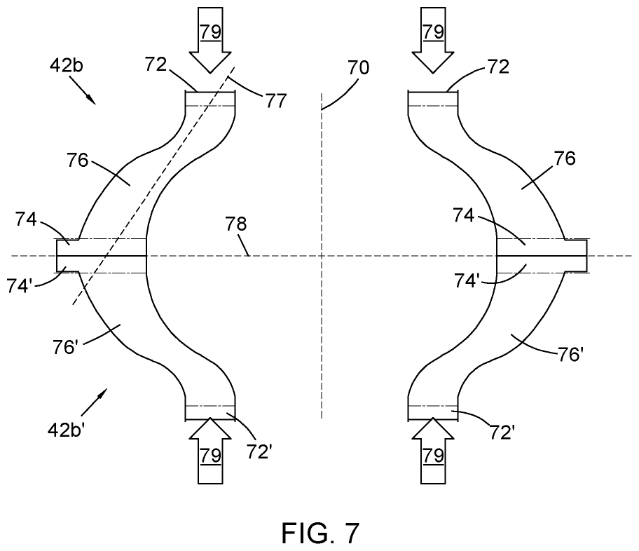

FIG. 7 shows an exemplary cross-sectional profile of two adjacent shells of an elastomeric compressive element;

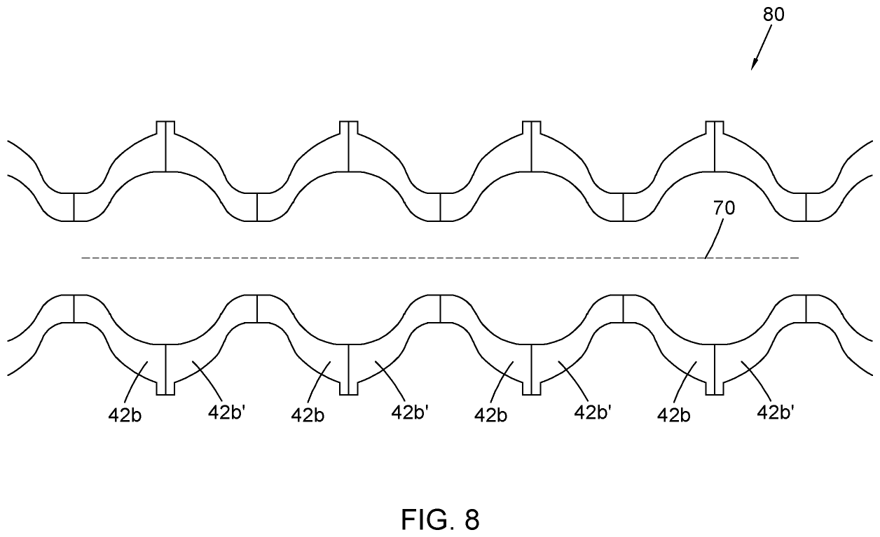

FIG. 8 shows a cross-sectional profile of a series of pairs of shells, as shown in FIG. 7, joined together to form a bellowed spring;

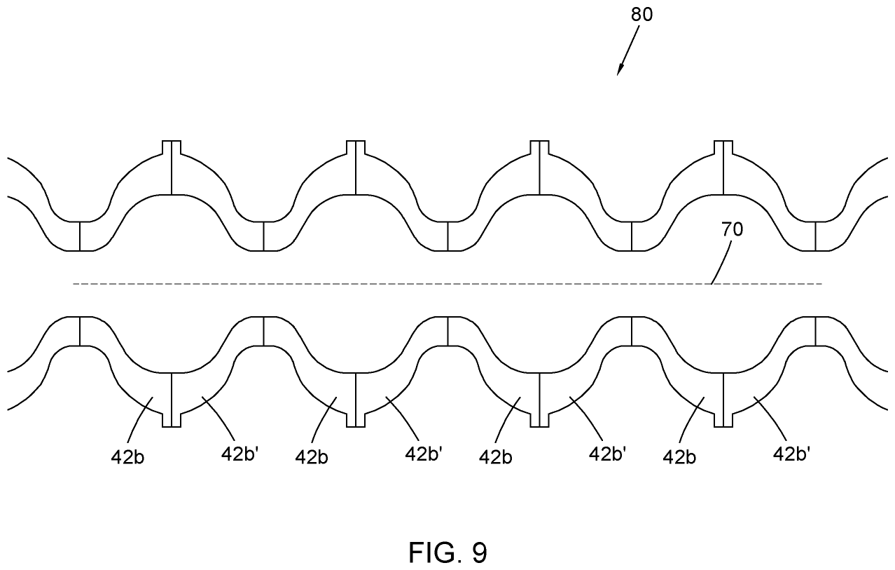

FIG. 9 shows the spring of FIG. 8 compressed to approximately the start of the second compression stage;

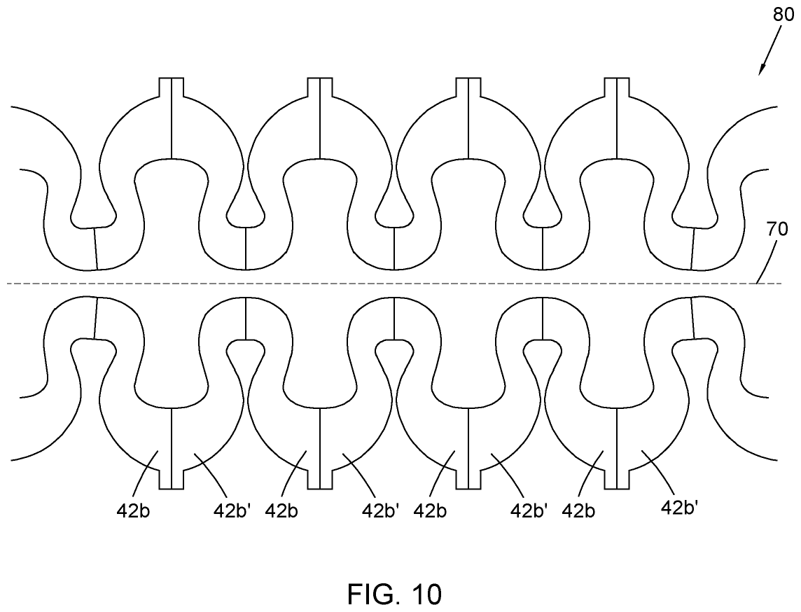

FIG. 10 shows the spring of FIG. 8 compressed to approximately the end of the second compression stage;

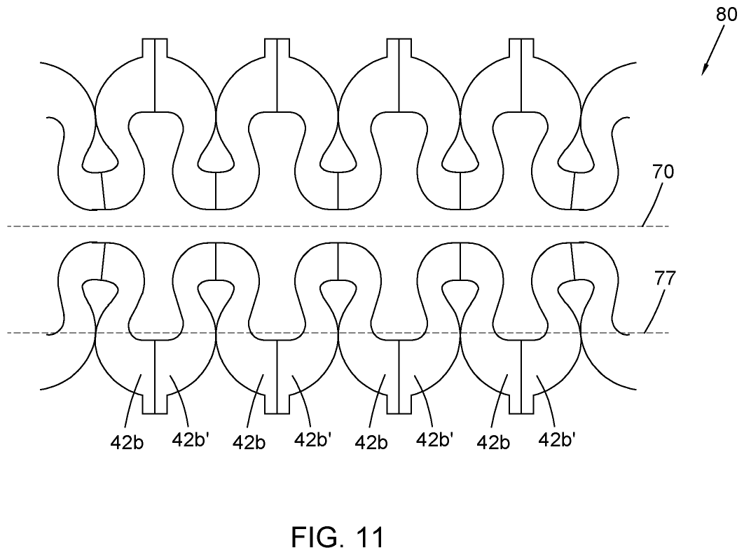

FIG. 11 shows the spring of FIG. 8 compressed to a point within the third compression stage;

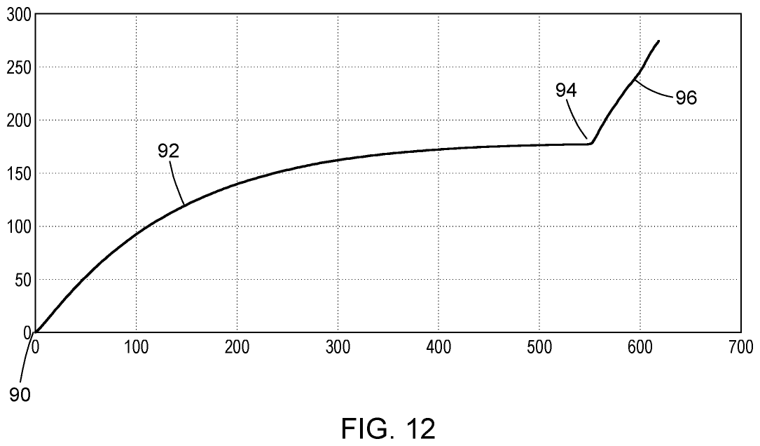

FIG. 12 is a graph showing the force response of the bellowed spring of FIGS. 8-11;

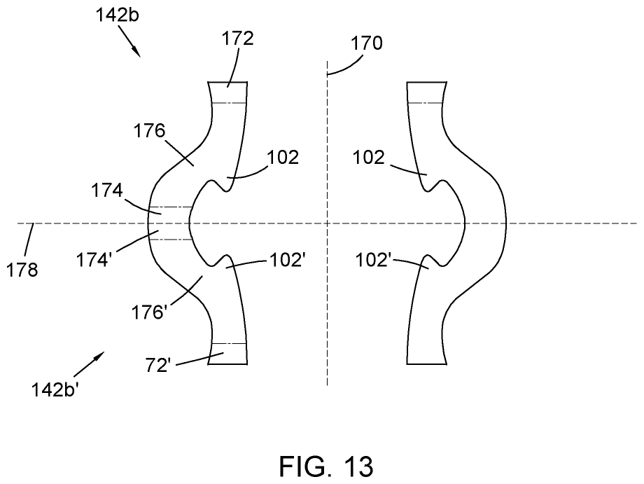

FIG. 13 shows another exemplary cross-sectional profile of two adjacent shells of an elastomeric compressive element;

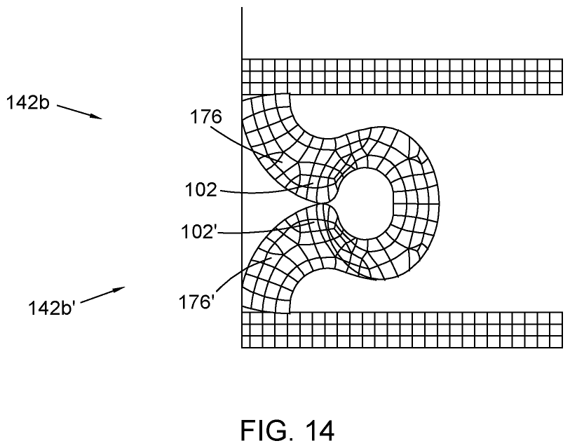

FIG. 14 is a cross-sectional profile of the shells of FIG. 13, when the adjacent shoulder portions have been brought into contact;

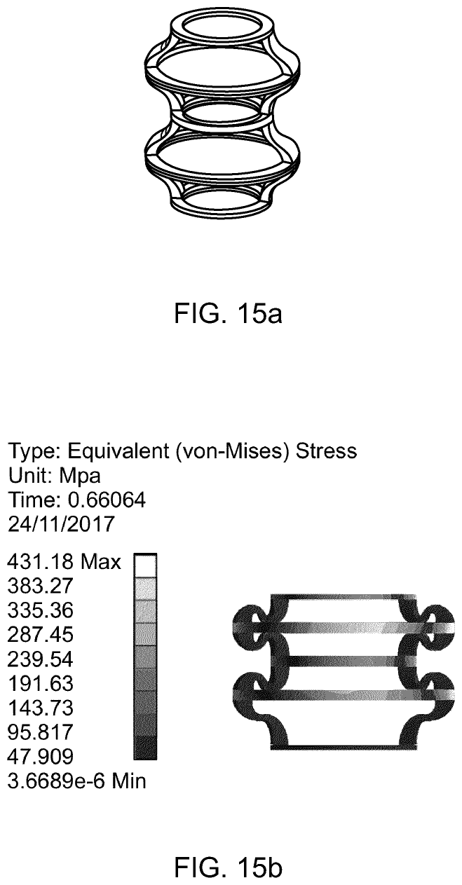

FIG. 15a shows an example of an elastomeric compressive element in which the central section comprises a number of profile sections; and

FIG. 15b shows the elastomeric compressive element of FIG. 15a under a compressive force.

Floating marine structures, such as floating offshore wind turbines, generally require a mooring system connected between the sea bed and the floating marine structure to keep the structure in place. Embodiments of a mooring component, for use in such a mooring system, will now be described.

FIG. 1a shows a floating offshore wind turbine 1, moored using a conventional catenary mooring system 2. The floating offshore wind turbine 1 is shown in two different positions, representing the position before and after the wind thrust is applied. A catenary mooring system comprises a length of chain, arranged so that one end is laying along the sea floor, whilst the other end is attached to the object that is moored. The horizontal arrow 3 represents the force acting on the mooring system as a result of wind causing action of the turbines 1.

This force 3 pushes the turbine 1 away from the direction of the wind. The initial tension in the mooring line is not sufficient to resist this motion and so the platform moves. As it moves more catenary chain 2 is lifted from the seabed increasing the tension in the mooring line, until an equilibrium position is reached where the horizontal component of the tension 5 in the mooring line balances the additional thrust due to the wind, shown by the dotted line 4.

FIG. 1b shows the stress strain response curve 11 produced by the catenary mooring system 2 of FIG. 1a. The x-axis 6 represents the distance X, in arbitrary units, that the turbine has been displaced from its ‘neutral’ position. This is the position in which the catenary mooring system 2 holds the turbine 1 when there is no thrust acting on the system due to wind, i.e. the position of the wind turbine 1 when the catenary chain is in position 2. The y-axis 8 represents the tension, in arbitrary units, present in the chain of the catenary mooring system. The additional wind thrust moves the platform to a new position 10, where the stiffness response of the mooring system (the additional tension required to move the platform) is much higher than in the original ‘neutral’ position.

It can be seen from this graph that, at large displacements from the ‘neutral’ position, a small amount of wave induced motion 7 results in a very large change 9 in tension experienced by the mooring system. This increases the size that the mooring components need to be so as not to break under the maximum tension. At these large displacements, for example at a point 10, the system is said to have high stiffness. This stress-strain response is undesirable as in high sea states the waves can induce large changes in the displacement X of the turbines 1. This can cause huge tension peaks to occur in the mooring system, which in turn induces fatigue in the system and raises the likelihood of failure of the mooring line.

FIG. 2a shows a mooring system containing a mooring component having multiple elastomeric compressive elements, in accordance with an embodiment of the present invention. In this example the elastic compressive elements are connected along the same length of mooring line, i.e. “in series”. The turbine 1′ is once again subject to the wind force 3′, moving the platform away from the direction of the wind until the horizontal component of the tension 5′ matches the wind thrust. FIG. 2b is a stress-strain response graph of the mooring component. The graph shows the response curve 20 provided by the mooring system shown in FIG. 2a containing the mooring component in comparison to the response curve 11 of the conventional catenary mooring system (as shown in FIG. 1a).

Certain features of the compressive elements are designed to give a stress-strain response as described herein, and the thrusts at which each stage of the stress-strain response begins are selected by adjusting these features, so as to be suitable for a particular mooring environment.

In this case, the compressive elements are designed such that the thrust load, which moves the turbine to the position shown on the right of FIG. 2a, in which the thrust load is balanced by the horizontal component of the tension in the mooring line 5′, compresses each compressive element to within the second stage of compression. As seen in the graph of FIG. 2b, at this position 10′, which is within stage 2 of compression (the operational range of the component), the stress-strain response curve flattens out such that a change of the platform displacement 7′, for example due to a wave, only results in a small change in the tension 9′.

As shown in FIG. 3, an example of a stress-strain response (as also shown in FIG. 2b), which is more desirable than the conventional response shown in FIG. 1b, can be broken down approximately into three separate stages. The x-axis 36 in FIG. 3 shows stress, in arbitrary units, whilst the y-axis 38 represents strain, again in arbitrary units. This stress-strain response may be scaled to a particular value depending on the system in which it is intended to be incorporated.

In the first stage 30, up to a first value 35 of the stress, a mooring system having the response of FIGS. 2b and 3 exhibits a high stiffness. This high stiffness causes a small extension of the mooring system to result in a large increase in thrust. In some examples, the mooring system will not operate within this range, in use, as pre-tension and thrust load acting on the mooring system when in use will pre-compress the compressive element such that the system operates in the second stage of compression 32. Should for some reason the thrust load not be present and the pre-tension not be high enough so that the experienced tensions are within this second stage, the high stiffness of the component in the first stage results in the overall mooring system behaving as a traditional mooring system within this range.

In the second stage 32, above the first value 35 of the stress and up to a second value 37 of the stress, the mooring system has a gently sloping response curve, thus having a lower stiffness than in the first stage 30. This is the operational range of the component and the first value is chosen based on the turbine thrust and pre-tension as described above, while the second value 37 is chosen based on the ultimate limit state. In this second stage 32, a change in platform position away from the anchor (e.g. due to a wave) will result in a small but appreciable increase in tension on the mooring line, and vice versa. If the response in the second stage 32 of the stress-strain response curve is too flat, then a small increase in the wind thrust applied to the platform will result in a large increase in the extension of the mooring line, leaving very little extension available for managing wave motions.

In the third stage 34 of the stress-strain response curve, above the second value 37 of the stress, the extension of the mooring line is large. In the third stage 34, the mooring exhibits a high stiffness once again, such that a small extension of the mooring system results in a large increase in thrust. This is designed to ensure that the platform is kept within a target surge (distance from the ‘neutral’ position) and to ensure that the component can manage unexpected loads.

The Applicant has designed a polymer mooring component, in accordance with at least preferred embodiments of the present invention, with particular design features that aim to implement each of the stages 30, 32, and 34 of the stress-strain curve. These various features will be described in greater detail below.

The stress-strain curve, as achieved by the polymer mooring component, in accordance with at least preferred embodiments of the present invention, provides a number of benefits to a mooring system. The risk of failures during shock loading is reduced, which reduces repair and insurance costs; smaller components can be used to deliver the same capability of a much larger mooring chain, thereby reducing the component cost and the deployment cost; and also reducing the operational costs since fewer repairs to the infrastructure are required.

FIG. 4 shows a cross-sectional view of an elastomeric compressive element 40 according to an embodiment of the present invention. FIG. 5a shows the external appearance of the elastomeric compressive element 40 shown in FIG. 4. FIG. 5b shows a cutaway perspective view of the elastomeric compressive element 40 shown in FIG. 4. This cutaway view shows a section of the outer surface cut away to show the inner structure. FIG. 5c shows a cross-sectional view of the elastomeric compressive element 40 shown in FIG. 4. This cross-sectional view shows the front half of the element cutaway. FIG. 5d shows an exploded perspective view of the elastomeric compressive element shown in FIG. 4, where the polymer spring is assembled from eight identical individual polymer shells.

The elastomeric compressive element 40 in the embodiment shown in FIGS. 4, 5a, 5b, 5c and 5d comprises four bellows, or convolutes, consisting of eight shells in total, arranged end-to-end along a single axis. Through the centre of the bellows there are arranged four steel rods, parallel to the central axis along which the bellows are arranged. As one of the steel rods is in front of the other from the perspective of FIG. 4, only three steel rods 44a, 44b, 44c can be seen. Two of the steel rods 44a, 44b are each attached at a first end to a first outer plate 46a and are attached at a second end to a second inner plate 48b, which is attached to the end of the row of bellows. The other two steel rods 44c are similarly attached between a second outer plate 46b and a first inner plate 48a. The steel rods 44a, 44b, 44c each comprise an I-beam.

The elastomeric compressive element 40 can be incorporated into a mooring line by attaching the outside of each of the outer plates 46a, 46b to sections of the mooring line. The end of the mooring line sections can then be in contact with a sea bed, e.g. via an anchor, whilst the end of the other section of the mooring line can be connected to a floating body which is to be moored, for example a floating offshore wind turbine.

Owing to the arrangement of the inner and outer plates 46a, 46b, 48a, 48b, as the tension in the line increases, each of the first and second outer plates 46a, 46b is acted on by a tensile force, in the direction along the axis of the bellows and away from the bellows. These tensile forces are shown by the arrows 41, 41′. As a result of these tensile forces, the inner end plates 48a, 48b each apply an inwards compressive force onto the bellows, as shown by the force arrows 43, 43′.

Each of the bellows comprises two halves, also known as “shells” 42a, 42a′, 42b, 42b′, 42c, 42c′, 42d, 42d′. Each of these shells is approximately identical. The shells can be joined together by a number of possible methods, including welding. Alternatively, the elastomeric compressive element, including the bellowed shape, can be formed as a single piece. FIG. 5d shows an exploded perspective view of the elastomeric compressive element 40 as shown in FIG. 4. The elastomeric compressive element 40 is shown in FIG. 5d in a “blown-up” format, so that each shell is shown separated and the steel rods can be seen through the gaps between adjacent shells.

FIG. 6a shows a perspective view of a single shell 42a of the elastomeric compressive element 40 shown in FIGS. 5a to 5d, during the second stage of compression (i.e. compressed to a stress value higher than 35 in FIG. 3). FIG. 6b shows a cutaway perspective view of the single shell 42a shown in FIG. 6a. The cutaway perspective view shown in FIG. 6b shows the profile of the thickness of the shell material.

The Applicant has appreciated that various features of the profile of the shell contribute to the three stages 30, 32 and 34 as shown in FIG. 3, as will be described below. The desired stress-strain response can be achieved by adjusting a large variety of parameters of the shells or compressive element, and the examples given below are intended to be exemplary but not limiting.

FIG. 7 shows a cross-sectional profile of two adjacent shells 42b, 42b′ of an elastomeric compressive element, according to an embodiment of the present invention, in an uncompressed state. In order to assist in understanding, the dashed line 78 shows the separation between the upper shell 42b and the lower shell 42b′, as shown in FIG. 7. This distinction may be merely conceptual, since a series of such shells i.e. a compressive element, may be integrally formed.

Each shell 42b, 42b′ comprises a first, outer, annular portion 74, 74′ and a second, inner, annular portion 72, 72′, with a central section 76, 76′ extending between them. The shells 42b, 42b′ are formed by rotating the shell profile, as shown in FIG. 7, through 360 degrees around a central axis 70, giving a two-sided symmetric profile shape as shown in FIG. 7.

One or both of the first, outer, annular portion 74, 74′ and the second, inner, annular portion 72, 72′ may be strengthened. For example, these annular portions 72, 72′, 74, 74′ may be thicker than the central section 76, 76′ of the shell and/or they could be made of a higher grade or stiffer polymer material than the central section 76 of the shell.

FIG. 8 shows a series of such shells 42b, 42b′, joined together to form the bellows of the elastomeric element of the mooring component. The bellows 80 (also referred to as convolutes) are in an uncompressed state in FIG. 8 i.e. 0% compression, when no load is applied to the bellows 80. The stages of compression of the bellows 80 will be described below with reference to FIGS. 9, 10 and 11, and the response curve of FIG. 12.

FIG. 12 is a graph representing the force response of bellows 80 to compression. The x-axis shows displacement in units of mm, and the y-axis shows the resistance force produced by the bellows 80, in units of kilo-Newtons (kN). FIG. 8 represents the compression at point 90, i.e. 0% compression of the bellows 80.

FIG. 9 shows the cross-sectional profile of the two adjacent shells 42b, 42b′, in a partially compressed state, i.e. at point 92 on the graph of FIG. 12. The partially compressed state of the shells 42b, 42b′ corresponds approximately to the first stress value 35 shown in FIG. 3, i.e. the start of the second phase of compression. In these exemplary bellows 80, this occurs at a compression of approximately 10% (of the uncompressed length shown in FIG. 8). It is clear from comparison of FIGS. 8 and 9 that the shells 42b, 42b′ of the bellows 80 substantially maintain their shape during the first phase of compression (i.e. compression from the arrangement of FIG. 8 to the arrangement of FIG. 9), and thus upon initial compression, the compressive element 80 comprising shells 42, 42′ with a cross-sectional profile as shown in FIG. 7 will deform very little. This may for example be achieved through selection of a suitable material stiffness.

When the shells 42b, 42b′ are joined together to form the bellows of the elastomeric compressive element of the mooring component, the relative distance of the annular portions 72, 72′, 74, 74′ (where the shells 42b, 42b′ join) from the central axis 70 defines a load pathway 77. It is along this pathway 77 (for a particular shell) that the compressive force 79 applied to the elastomeric compressive element is transmitted. This occurs because a load pathway 77 as shown in FIG. 7 forms a relatively small angle with the central axis 70, causing the compressive element to have a relatively high stiffness in the configuration shown in FIG. 7. This stiff response can be seen in the steep gradient of the stress-strain response curve shown in FIG. 3 (and FIG. 12).

As the compressive force on the compressive element increases, the shells 42b, 42b′ flex (about the first, outer, annular portion 74, 74′ and the second, inner, annular portion 72, 72′). As the compression of the compressive element increases, the angle of the load pathway 77 with the central axis 70 increases. Approaching and through the change from the first to second stages 30, 32 of stress-strain response curve (as shown in FIG. 3), the gradient of the stress-strain response curve lessens as the compressive element becomes less stiff. This is also seen in the particular response curve graph of FIG. 12. This lower gradient of the stress-strain response curve continues through the second stage 32 until the second stress value 37 is reached, as described below with reference to FIG. 10. FIG. 10 shows the cross-sectional profile of the two adjacent shells 42b, 42b′, in a compressed state, corresponding approximately to point 94 in FIG. 12. Thus FIG. 10 shows the state of compression of the bellows 80 approximately at the end of the second phase 32 of compression. It can be seen in FIG. 10 that some of the adjacent shells 42b, 42b′ are just starting to come into contact at the adjacent outer sides of their respective central sections 76, 76′. This results in a sharp increase in the stiffness of the bellows 80, and therefore produces the large increase in gradient seen after the point 94 on the graph of FIG. 12. Specifically, the contacting of the outer surfaces of the central sections 76, 76′ of adjacent shells 42b, 42b′ changes the load pathway 77 to reduce the angle between the load pathway 77 and the central axis 70. This produces the increased stiffness seen in the graph of FIG. 12.

Further compression beyond this compression value further increases contact between adjacent shells 42b, 42b′, as shown in FIG. 11. FIG. 11 shows the compression of the bellows 80 at approximately the value 98 shown on the graph of FIG. 12. It can be seen that this contact gives a load pathway 77 approximately parallel to the central axis 70 resulting in the high stiffness. This high stiffness at large compression ensures that the bellows are able to withstand thrust values which occur in the Ultimate Limit State (ULS) of the mooring system.

Additionally, or alternatively, some or all of the features of the response curve achieved herein may be achieved by including one or more shoulder portions on the shell. A shoulder portion is essentially a more pronounced thickening of a portion of the shell, extending in a direction away from the shell, as described above.

One example of such a shell is shown in FIG. 13.

FIG. 13 shows a cross-sectional profile of two adjacent shells 142b, 142b′ of an elastomeric compressive element, according to another embodiment of the present invention. In order to assist in understanding, the dashed line 178 shows the separation between the upper shell 142b and the lower shell 142b′, as shown in FIG. 13. This distinction may be merely conceptual, since a series of such shells i.e. a compressive element, may be integrally formed.

Each shell 142b, 142b′ comprises a first, outer, annular portion 174, 174′ and a second, inner, annular portion 172, 172′, with a central section 176, 176′ extending between them. The shells 142b, 142b′ are formed by rotating the shell profile, as shown in FIG. 13, through 360 degrees around a central axis 170, giving a two-sided symmetric profile shape as shown in FIG. 13.

Each central section 176, 176′ comprises a respective inner shoulder portion 102, 102′ that projects from the inner surface of the central section 176, 176′ towards the first, outer, annular portion 74, 74′. Contact between adjacent shoulder portions 102, 102′ may give rise to the third phase of the response curve, in a similar manner to that described above. Contact of the adjacent shoulders 102, 102′ is illustrated in FIG. 14. Alternatively, the shoulder portions 102, 102′ may be arranged to contact at any desired point during the stress-strain response curve, to assist in providing the desired response curve. Multiple such shoulders may be provided on both the inner and/or the outer surfaces of the shells 42b, 42b′, both in the annular portions and in the central section.

As described, the shells 42b, 42b′, 142b, 142b′ are formed by rotating the shell profile, as shown through 360 degrees around the central axis 70, 170, thus forming a solid of revolution.

Alternatively, a shell may comprise a plurality of profile sections, each consisting of rotations of the profile shown about the axis 70 through only certain limited angles, of less than 180 degrees. In this latter case, multiple profile sections are then joined to the first, outer, annular portion 74, 74′, 174, 174′ and the second, inner, annular portion 72, 72′, 172, 172′. Each of the annular portions 72, 72′, 74, 74′ extend (and are thus continuous) through 360 degrees. One such example is shown in FIGS. 15a and 15b.

FIG. 15a shows an example of an elastomeric compressive element in which the central section comprises a number of profile sections, which are joined at the top and bottom circumferences. The Applicant has appreciated that these portions must be at least partial revolutions of the shell profile described already through at least a minimum angle, in order to give the desired non-linear response curve, otherwise the response profile of the shell will be similar to that of a beam, and not show the desired non-linear response. FIG. 15b shows the deformation of the elastomeric compressive element of FIG. 8a when acted on by a compressive force.

It will be appreciated by those skilled in the art that the invention has been illustrated by describing one or more specific embodiments thereof, but is not limited to these embodiments; many variations and modifications are possible, within the scope of the accompanying claims.

1. A mooring component comprising:
at least one compressive element arranged to undergo compression in response to a tensile stress experienced by the mooring component, wherein the at least one compressive element is arranged such that compression of the at least one compressive element induces an extension of the mooring component;
wherein the at least one compressive element is arranged such that a tensile stress experienced by the mooring component up to a first stress value of the tensile stress compresses the at least one compressive element in a first stage of compression by up to a first fraction of an uncompressed length of the at least one compressive element;
wherein the at least one compressive element is arranged such that a tensile stress experienced by the mooring component above the first stress value of the tensile stress and up to a second stress value of the tensile stress further compresses the at least one compressive element in a second stage of compression by greater than the first fraction of the uncompressed length of the at least one compressive element and up to a second fraction of the uncompressed length of the at least one compressive element;
wherein the at least one compressive element is arranged such that a tensile stress experienced by the mooring component above the second stress value of the tensile stress further compresses the at least one compressive element in a third stage of compression by greater than the second fraction of the uncompressed length of the at least one compressive element;
wherein during the first stage of compression the at least one compressive element exhibits an average stiffness having a first stiffness value, wherein during the second stage of compression the at least one compressive element exhibits an average stiffness having a second stiffness value, and wherein during the third stage of compression the at least one compressive element exhibits an average stiffness having a third stiffness value; and
wherein the first stiffness value is greater than the second stiffness value, and the third stiffness value is greater than the second stiffness value.

2. The mooring component of claim 1, wherein the first fraction is between 10% and 20% of the uncompressed length.

3. The mooring component of claim 1, wherein the value of the third stiffness value is at least 50% greater than the second stiffness value.

4. The mooring component of claim 1, wherein a gradient of the stress-strain curve of the at least one compressive element is positive for all values of the tensile stress up to the first stress value.

5. The mooring component of claim 1, wherein the second fraction is between 40% and 60% of the uncompressed length.

6. The mooring component of claim 1, wherein the compression of the at least one compressive element is approximately proportional to the tensile stress experienced by the mooring component between the first and second stress values of the tensile stress.

7. The mooring component of claim 1, wherein the gradient of the stress-strain curve of the at least one compressive element is positive for all stress values of the tensile stress between the first and second stress values.

8. The mooring component of claim 1, wherein each of the at least one compressive element comprises a plurality of shells, wherein each of the plurality of shells comprises a first annular portion, a second annular portion and a central section, and wherein the central section connects and extends between the first annular portion and the second annular portion.

9. The mooring component as claimed in claim 8, wherein the at least one compressive element is arranged such that when the compressive stress applied to the at least one compressive element causes the at least one compressive element to be compressed by a particular fraction of the uncompressed length of the compressive element, a first portion of one of the plurality of shells contacts a first portion of an adjacent shell of the plurality of shells.

10. (canceled)

11. (canceled)

12. The mooring component of claim 9, wherein the first portions of adjacent shells of the compressive element are arranged to contact each other in the third stage of compression.

13. (canceled)

14. The mooring component of claim 1, wherein the compression of the at least one compressive element is approximately proportional to the tensile stress experienced by the mooring component above the second stress value of the tensile stress.

15. The mooring component of claim 1, wherein a gradient of the stress-strain curve of the at least one compressive element is positive for all stress values of the tensile stress above the second stress value.

16. The mooring component of claim 1, wherein the additional compression of the at least one compressive element during the third stage of compression is less than 10% of the uncompressed length of the at least one compressive element.

17. (canceled)

18. The mooring component of claim 1, wherein the mooring component is formed from at least two materials having different mechanical properties.

19. The mooring component of claim 1, wherein the mooring component is formed from at least one polymer material.

20. The mooring component of claim 1, wherein the mooring component is formed integrally as a single piece.

21. The mooring component of claim 1, wherein the mooring component exhibits a non-plastic response during the first and second stages of compression.

22. The mooring component of claim 1, further comprising a first inner plate, connected to one end of the compressive element, a second inner plate connected to the other end of the compressive element, a first outer plate adjacent to the first inner plate for connecting to a first portion of a mooring line, a second outer plate adjacent to the second inner plate for connecting to a second portion of a mooring line, a first connecting member connected to the first inner plate and the second outer plate and a second connecting member connected to the second inner plate and the first outer plate.

23. The mooring component of claim 18, wherein the first and second connecting members comprise first and second connecting rods or ropes or chains.

24. A mooring system comprising:
the mooring component of claim 1, and
a mooring line,
wherein the mooring component is arranged between a first section of the mooring line and a second section of the mooring line, such that tensile stress applied to the mooring line acts to compress the compressive element and causes the overall length of the mooring system to increase.

25. (canceled)
